(19) United States
(12) Patent Application Publication
(10) Pub. No.: US 2008/0047814 A1
(43) Pub. Date: Feb. 28, 2008

(54) Keypad and compact video device equipped therewith, provided with a screen

(75) Inventors: Henri Crohas, Verrieres Le Buisson (FR); Laurent Mazingue, Paris (FR)

Correspondence Address: YOUNG & THOMPSON, 745 SOUTH 23RD STREET, 2ND FLOOR, ARLINGTON, VA, 22202, US

(73) Assignee: ARCHOS, IGNY (FR)

(21) Appl. No.: 11/882,176

(22) Filed: Jul. 31, 2007

(30) Foreign Application Priority Data
Jul. 31, 2006 (FR) 06/07004

(51) Int. Cl. H01H 23/04

(52) U.S. Cl. 200/5 A

(57) ABSTRACT

The pocket video player comprises a screen 1 and a keypad 2. The keypad 2 is composed of rocking keys each controlling two antinomic functions which cannot be activated simultaneously. Three of the adjacent keys (4c, 4d, 4e) constitute a navigator with rocking keys. The central key (4d) controls two opposite directions and the two side keys (4c, 4e) each control one of the two other directions respectively. Useful for increasing the size of the screen, reducing the size of the keypad, and making the actuation of the functions easier and more reliable.

This invention relates to a keypad for a device provided with a screen, in particular for a compact portable video player of the type of device intended for the pocket or handbag, organiser, etc.

This invention also relates to a device of this type with a screen, equipped with the keypad.

Compact video devices comprise keys of the push-button type for controlling their various functions. The user presses a key to activate a corresponding function. A key of the navigation cross type allows the user to manoeuvre in the four directions throughout a menu displayed on the screen.

The press-buttons must be of a certain size and have a certain spacing between them, to avoid unwanted double actuation. Even if such spacing is respected, it is still possible for a user to activate two conflicting functions simultaneously.

The navigation cross also takes up space, as it requires three rows of actuation detectors such as contacts, namely a row for two opposing directions of navigation and a row with a single detector for each of the other two directions of navigation.

The space occupied by the control keys means that the size of the screen must be reduced, although the user desires the screen to be as large as possible for the given dimensions of the portable video player, which are necessarily limited.

The object of this invention is thus to provide a keypad having reduced dimensions and therefore allowing the screen size to be increased for the given total dimensions of the device.

Another object of this invention is to provide a video device, in particular a pocket portable video player, having a particularly large screen surface in relation to its total dimensions.

Yet another object of this invention is to provide a keypad which reduces or removes the risk of simultaneous operation of two conflicting functions.

Yet another object of this invention is to produce a keypad which is cheaper than those of the state of the art.

According to the invention, the keypad for a video device, particularly a portable video player, is characterized in that it comprises at least one control key having on either side of an inactive zone situated above a mechanical support for the key, two opposed zones actuated by being depressed by the user, intended for activation of two different functions.

Thus a single key is used to provide a means of control for two different functions. The inactive zone is used to distinguish between these two functions, preventing the user from taking an action which would result in the simultaneous activation of two different functions. Even if the user presses the whole surface of the key, the effect obtained will be to activate only one of the two functions, or neither of them.

Thanks to this safeguard provided by the inactive zone of the key, the two active zones for actuation can be closer to each other than two independent press-buttons known from the state of the art.

Thus according to the invention an economic and compact keypad can be made, with a reduced number of relatively small keys, making it possible to increase the screen size of the video device in which it is installed.

Preferably, the two different functions which can be activated by the same key are antinomic. These can be two navigation functions in two opposing directions, an acceptance function and a rejection function, etc.

In certain circumstances, it is envisaged according to the invention to associate other functions with the keys, other than those which are allocated to them as a priority. Generally the associated priority functions are indicated by icons marked directly on the keys, either in relief or otherwise. In certain circumstances such as keying in a telephone number or keying in strings of characters, it is envisaged according to the invention to depart from the associations of priority functions. In this non-limitative example, in view of the small number of keys available for selection of 10, 12, 26, 36 characters or more, several characters are associated with the same key. For each key concerned, input is sequential by successively pressing the key until reaching the desired character. In a simple embodiment, once the character displayed in the current input zone corresponds to the desired character, this choice must be validated explicitly by pressing the acceptance key. Validation of the character allows the following character to be entered. A second press on the confirmation key closes the input session. The efficiency of keying-in will be substantially increased by managing the time between each press on a single key and by detecting the key changes to validate the selected characters implicitly, for example according to the methods known from the state of the art in telephony. The display means of the device are used to offer a graphical representation of all or part of the keypad including the elements of information indicating the function associated with each key. Advantageously, the display of the relevant keys of the keypad and their meaning is positioned at the edge of the screen, as close as possible to the keypad, directly opposite the keys, and if possible with corresponding dimensional and/or aesthetic characteristics between the keys and their representation. Bearing in mind the potentially dynamic nature of the display, the allocation of functions will advantageously be adapted to the context of the application. For example when it is desired to input a telephone number, there is no need to display alphabetical characters. The ten numbers, and the few additional symbols such as the star and hash, can be distributed over the whole of the available resources in order to minimise the number of sequential presses. Similarly, if it is desired to input the name of a contact, there is no need to offer the ten numbers.

Preferably, the keys act on actuation detectors placed under the actuation zones. The keys can be of the substantially motionless type, the detectors being for example of the piezoelectric, piezo-resistive or capacitive type, arranged on either side of a rigid support for the key under the inactive zone.

The actuation detectors can also be contacts from the state of the art, with or without tactile feedback, activated by rocking the key in one direction or the other about a shaft close to the inactive zone. These are for example contacts made of elastomer or preferably, metal-domed contacts which offer the advantage of clear tactile feedback which increases the impression of quality.

In one embodiment, the mechanical support situated under the inactive zone of the key is made in the form of a hinge between the key and a base which typically carries the actuation detectors.

Assembling the key with the base is preferably carried out by a simple hinge assembly, even more preferably by passing a pin through at least one pivot bearing carried by the base and at least one pivot bearing carried by the key.

Preferably, the keypad comprises at least two adjacent keys hinged to the base by a common pin. Advantageously, the base and the keys comprise pivot bearings through which the common pin passes and which abut each other laterally to define the axial positioning of the keys and the clearance between the keys.

According to an improvement of the invention, the keypad comprises a pre-stressed elastomer interface which is in compression between the base and the key or keys. The keys can be pre-assembled together by being fixed onto the interface, which is then common to the adjacent keys. There can, for example, be a single interface for five successive keys.

The interface preferably has actuation projections on its surface facing the base. When the user actuates a key by pressing an actuation zone of this key, the pressure is transmitted by the interface, more particularly by an actuation projection of the interface, which in turn acts on the actuation detector carried by the base.

The interface can also have support projections on its surface facing the base, to localize the pre-stressed support of the key on the base.

Preferably, the elastomer interface is installed in a pre-stressed condition under compression between the base and the keys. The interface thus acts as a means of returning the key to a neutral position where neither of the two functions is activated. The user can only move the key out of its neutral position by exceeding a pressure threshold defined by the pre-stress of the interface. At the same time, the pre-stress of the interface removes any play which may have existed between the key and the base when the key is in its neutral position. Therefore the keys do not click when the device is manipulated and the impression of quality is improved.

According to another aspect of the invention, the keypad comprises means of tactile identification to facilitate its use without recourse to the visual aid.

For example, the two actuation zones of a key can have differences in shape which can be felt by the user's finger. One key actuation zone can be concave and the other convex, the key typically having a profile in the shape of a horizontal letter S when seen in elevation.

According to an important feature relating to identification, the keypad with several keys comprises a tactile identification pattern common to at least two keys, which straddles the respective user-accessible faces of the two keys. The user's finger can thus follow paths extending over at least two keys, to find actuation zones successively, in an order which is logical in relation to the functions controlled by these successive actuation zones.

According to yet another aspect of the invention, an original navigator is proposed, to replace the usual navigation cross. This navigator extends over three double-function keys according to the invention, namely a central key for controlling two navigation functions in two opposing directions, and on either side of the central key, two side keys each control two other functions, one of which is a navigation function in one of the two respective directions perpendicular to the two opposing directions of the central key. Advantageously, the second function controlled by each of the two side keys is an accelerated navigation function in the perpendicular direction associated with the same side key, or also in a direction dependant on the context of use.

It is also very advantageous that the navigator thus constituted should comprise a tactile identification pattern, preferably a recess, the contour of which extends over the three keys to delimit with a certain precision the region where the four actuation zones corresponding to the four navigation directions are situated.

The invention also relates to a compact portable device provided with a screen, in particular a video device, of the pocket or handbag type, comprising a keypad according to the invention.

According to an improvement, the device is capable of showing the image in two mutually reversed directions in which the keypad is situated respectively to the right and to the left of the screen, for the convenience of respectively, a right-handed person and a left-handed person.

An item relating to the choice of direction of use can be provided for this purpose in the installation menu of the video device. It can also be envisaged that the direction of use is detected by a contact or other gravity-sensitive component installed in the device, to automatically control the direction of presentation of the image.

It is possible for the keypad, or only its actuation sub-assembly comprising the keys fixed onto the interface, to be easily removed and turned through 1800, so that it always has an ergonomic orientation, whatever the direction of use of the device. A detector of the position of the sub-assembly can then on the one hand, control the direction of the image on the screen and on the other hand, define the correspondence table between the control functions on the one hand and the different actuation detectors of the base of the keypad on the other hand.

Other features and advantages of the invention will become apparent from the following detailed description, which relates to non-limitative examples.

In the attached drawings:

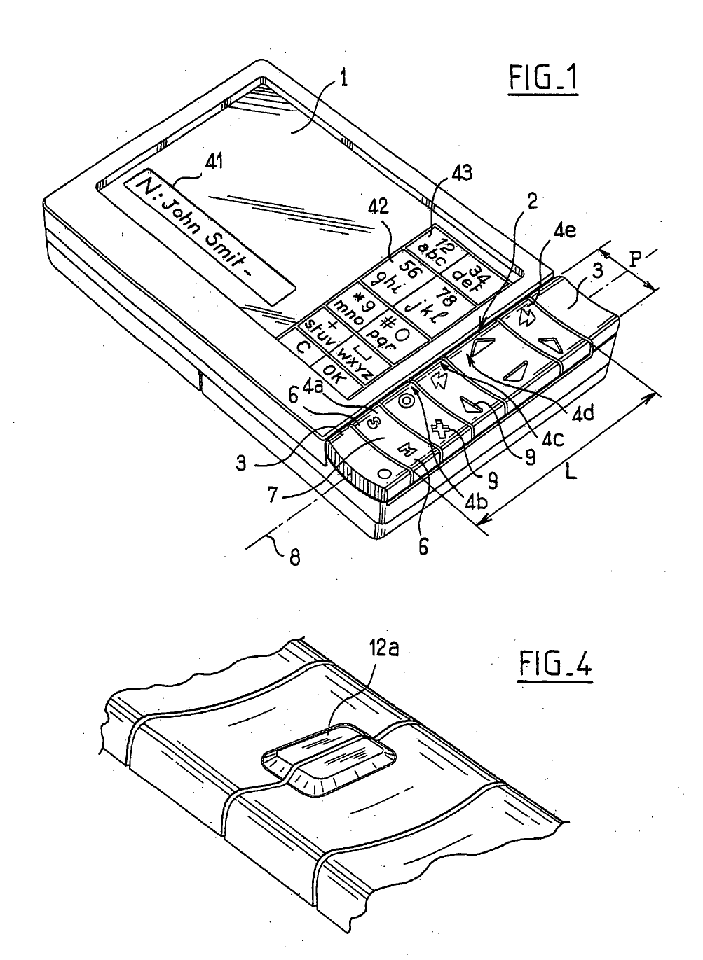

FIG. 1 is a perspective view of a pocket video device according to the invention;

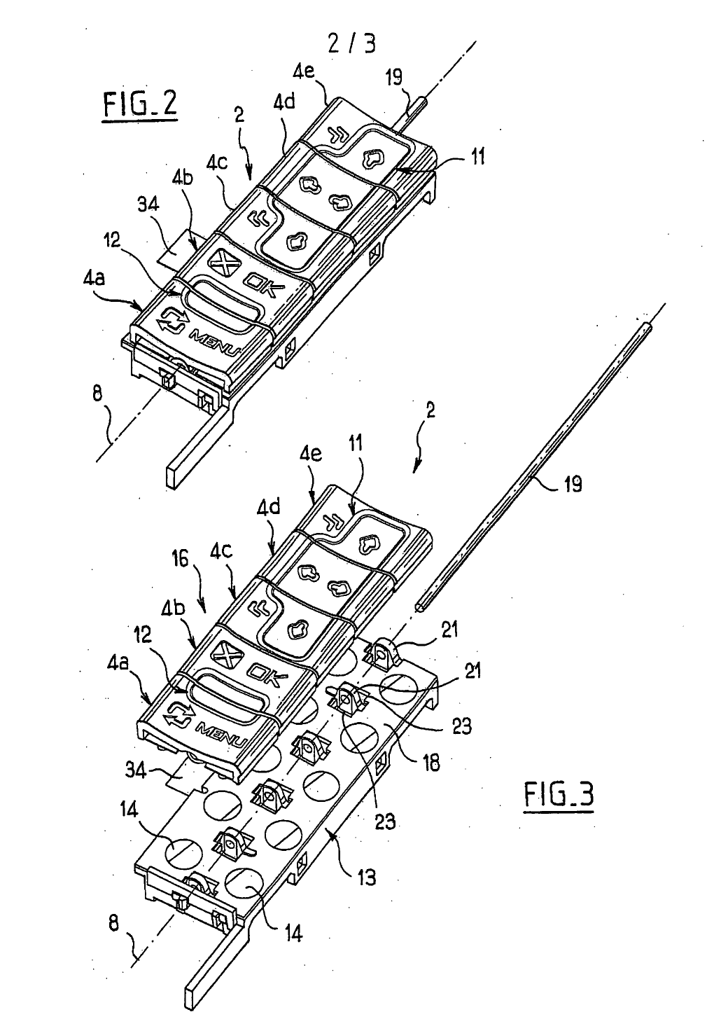

FIG. 2 is a perspective view of an embodiment of the keypad;

FIG. 3 is an exploded perspective view of the keypad in FIG. 2 showing the sub-assemblies of which it is composed.

FIG. 4 is a partial perspective view of an embodiment of the keys;

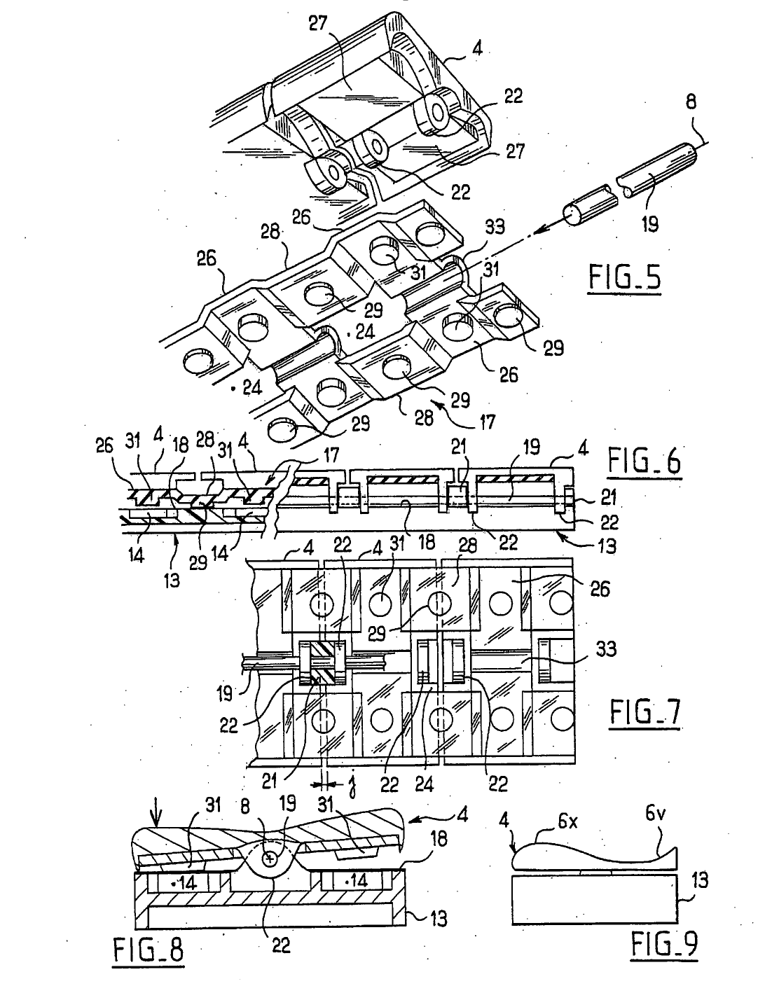

FIG. 5 is an exploded perspective view of the actuation sub-assembly;

FIG. 6 is a longitudinal cross-sectional view of the keypad, in two different sectional planes;

FIG. 7 is a bottom view of the actuation sub-assembly, with partial view of the pin and a pivot bearing of the base in the left part;

FIG. 8 is a transverse cross-sectional view of the keypad during an actuation; and

FIG. 9 is a schematic end view of a modified embodiment of the keypad.

In the example shown in FIG. 1, the pocket video player is presented in the form of a flat parallelepipedic object comprising a rectangular screen 1 occupying the greater part of one of the large faces of the parallelepiped beside a keypad 2 which extends over one of the widths of this large face, between two end trim covers 3. As an indication, the dimensions of the player are for example 13×7×1 cm approximately.

The length L of the keypad is for example approximately 50 mm and its depth P approximately 15 mm.

The keypad comprises keys 4a . . . 4e aligned in parallel to its length L. In the example, there are five keys.

According to the invention, each key 4 has two opposite actuation zones 6 situated on either side of an inactive zone 7 of the key. The inactive zones 7 are aligned over a longitudinal axis 8 of the keypad. The longitudinal axis 8 is parallel to the length L of the keypad. For each key, the two actuation zones 6 are situated on either side of the pin 8. Each actuation zone allows a corresponding function of the player to be activated, symbolized by an icon 9. To activate the function, the user presses with the finger on the corresponding actuation zone 6.

In the example which will be described more in detail, the keys 4 are rockable independently of each other about the longitudinal axis 8 in one direction of rocking or in the other from a neutral position in which neither of the two functions associated with the key is activated.

The key is supported mechanically under the inactive zone 7. Therefore the pressure of the user's finger in general has the effect that the key is more substantially pressed on one side of the axis 8 and that the actuation zone which is remote from the side receiving the majority of the pressure tends to be lifted up. If the user inadvertently presses centrally on the inactive zone 7, possibly on both sides of the latter with an equal pressure on both actuation zones, no activation will take place, as the pressure is completely absorbed by the mechanical support in place under the inactive zone 7.

Preferably, the two functions associated with a single key are antinomic, in the sense that their simultaneous activation is undesirable. In the example represented, the two functions which can be activated by the key 4a are the “Menu” function and the “Exit menu” function. The key 4b controls the “Accept” and “Reject” functions. Devices of the type envisaged by the invention ideally comprise a small number of keys, and an increasing number of functions is required by the average user. This can be obtained by giving a different function to a second, third etc. successive pressure on a single actuation zone. Information displayed on the screen can also temporarily allocate a different function to a particular actuation zone. In such cases, the notion of antinomy between the functions associated with the two actuation zones of a single key can be temporarily abandoned without leaving the framework of the antinomy feature provided for according to the invention.

According to one aspect of the invention, a navigator is grouped over three adjacent keys, namely keys 4c, 4d, and 4e of the keypad. The two actuation zones of the central key 4d control two mutually opposed navigation directions. The two side keys 4c and 4e each control respectively one of the two navigation directions perpendicular to the two opposed directions of the key 4d. The other actuation zone of each side key 4c or 4e controls scrolling at accelerated speed.

In the example represented, the two actuation zones for accelerated scrolling are aligned parallel to the longitudinal axis 8, in such a way that the four scrolling functions at normal speed have a T-shaped configuration. It would also be possible to arrange these four functions according to a Z-shaped configuration, i.e. for example by reversing the two functions which can be activated by the key 4e or those which can be activated by the key 4c.

FIG. 1 moreover illustrates a feature of the invention which is the ability at any time, according to the functional requirements of the device, to reallocate all or part of the keys to other functions than those represented by the icons 9 marked on the keys. In the example represented, all the available keys are reallocated to the functions linked to the input of alphanumeric characters 41. This reallocation depends on the display of a representation 42 of the new keypad thus constituted on the screen 1. In this example, the characters 43 have been distributed in a uniform manner over the representation of the largest possible number of keys in order to reduce the maximum number of sequential presses necessary to achieve all the characters. It is possible to make other allocation choices without exceeding the scope of the invention, for example by giving privileged access to the characters most frequently used. Similarly, in the non-limitative example represented in FIG. 1, the acceptance and cancellation functions are reallocated to other keys 4a than those normally intended for this purpose 4b in order to group together the keys involved in the input of characters 4b, 4c, 4d, 4e.

In a more particular embodiment represented in FIGS. 2 and 3, the keypad comprises tactile identification patterns on the visible face of the keys, i.e. the face accessible to the user's finger and which has the actuation zones and the inactive zone. In the example of FIGS. 2 and 3, these patterns are recesses which extend over the faces of several adjacent keys. These tactile identification patterns allow the user, after a period of practice, to be guided by touch to locate on the keypad the actuation zone corresponding to the function that it is desired to activate. Moreover, patterns 11, 12 guide the user from one actuation zone to another.

The identification patterns also have the function of defining a visual and tactile grouping of certain adjacent keys, and therefore a logical grouping of the functions which are activated by these keys.

In the more precise example represented, the pattern 11 groups in a visual and tactile manner the three keys 4c, 4d and 4e of the navigator. The contour of the recess 11 surrounds and groups together the four actuation zones for scrolling at normal speed in the four directions. Thus, the user accustomed to his player can select the scrolling directions by moving his finger within the recess 11, which has the general shape of T, like the arrangement already described of the four corresponding actuation zones. The two actuation zones for the accelerated scrolling are situated outside the recess 11. The user locates them by touch by crossing from the inside to the outside of the contour of the recess 11 on either side of the leg of the T.

The pattern 12 is also, in this example, a recess which the user's finger must go all the way round in order to encounter successively the four actuation surfaces of the two keys 4a and 4b. The recess 12 straddles the boundary between the keys 4a and 4b, being symmetrical on either side of the axis 8 and without reaching the edges of the assembly formed by the keys 4a and 4b.

In the modified embodiment represented in FIG. 4, the pattern 12 of FIGS. 2 and 3 is replaced by a pattern 12a constituted by a projection having substantially the same contour as the recess 12 of FIGS. 2 and 3.

Now, with reference to FIGS. 2, 3, 5, 6, 7, 8, the mechanical construction of the keypad in FIGS. 2 and 3 will be described. The keypad comprises a base 13 in which are installed two rows of actuation detectors 14 constituted in this example by micro-contacts of a known type. The two rows 14 are arranged parallel to the longitudinal axis 8. The keypad 2 also comprises an actuation sub-assembly 16 comprising the keys 4a to 4e already described, preassembled together by means of an elastomer interface 17 (FIG. 5) which once the keypad is assembled is interposed between the keys 4a to 4e on the one hand and an upper face 18 of the base 13 on the other hand.

Finally, the keypad 2 comprises a cylindrical pin 19 of greater or substantially equal length to L (FIG. 1) in order to connect the keys 4a to 4e in a hinged manner to the base 13.

To make this connection possible, the base 13 has on its upper face 18 six pivot bearings 21 aligned along the axis 8 and forming bearings for the cylindrical pin 19. Moreover, each key 4 (FIG. 5) has on its lower face two pivot bearings 22 intended to be placed between two successive pivot bearings 21 of the base 13, substantially without axial clearance between them, as shown in FIG. 6.

FIG. 6 and the left part of FIG. 7 also show that each pivot bearing 21 is positioned without axial clearance between two successive pivot bearings 22 belonging to two adjacent keys 4, thus defining between these two keys a very small clearance “j” (FIG. 7), of for example a few tenths of a mm, in order to allow the keys 4 to be actuated independently of each other in a reliable manner. The bearings 21 therefore form a spacer between the keys 4.

The longitudinal axis 8, about which the keys 4 can rock with respect to the base 13, extends close to the plane of the upper surface 18 of the base 13, where the sensitive faces of the actuating detectors 14 are situated. Thus, the sensitive faces of the detectors 14 are struck almost perpendicularly by each key. However, it is preferable for the axis 8 to be slightly offset towards the keys 4 with respect to the surface 18 so that the movement of the upper face of the keys 4 is substantially perpendicular to the adjacent external surface of the device, in order to minimise the functional clearance to be allowed for between the edges of the keys and the adjacent fixed parts. In order to position the pin 19 close to the upper face 18, the latter has on either side of the pivot bearings 21, recesses or openings 23 (FIG. 3) allowing the pivot bearings 22 of the keys to penetrate slightly inside the base 13 once the assembly is achieved. This penetration, shown in FIGS. 6 and 8, also has the effect of pre-positioning the pivot bearings 22 in axial alignment with the pivot bearings 21 during assembly, for insertion of the pin 19.

In practice, the surface 18 of the base 13 is made of an elastomer membrane which completely covers the micro-contacts 14 while transmitting to them the actuating forces received from the keys 4. The left part of FIG. 6 and FIG. 8 show that the body of the base supports the membrane in certain appropriate areas situated between the detectors 14 or around them.

The interface 17 is a plate having openings 24 (FIG. 5) for the passage of the pivot bearings 22, zones 26 for bonding by adhesive onto the corresponding lower faces 27 of the keys 4, bridges 28 which are free relative to the keys 4 and connect together the successive zones 26 bonded to adjacent keys 4. The bridges 28 are lower towards the base 13 with respect to the bonding zones 26 and comprise projections 29 which permanently bear on the surface 18 of the base 13 between the successive contacts 14 of a same row. Thus, the interface 17 establishes between the base 13 and the keys 4 a pre-stressing thanks to which the interface is pre-compressed between the base 13 and the keys 4, and the keys 4 are held under stress away from the base 13. Any play of the pin 19 in the pivot bearings 21 and 22 is thus eliminated. The above mentioned pre-stress returns the keys 4 to their neutral position in which neither of the two functions associated with each key 4 is activated. When a key 4 is actuated in one direction or the other with respect to this neutral position, as represented in FIG. 8, this corresponds to an additional local compression of the interface 17 with deformation of the two bridges 28 situated on either side of the zone 26 bonded to the key 4 on the side where the latter is pressed by the user.

On the side facing the base 13, the zones 26 for bonding to the key 4 each have an actuation projection 31. As shown in the left part of FIG. 6, when the keys 4 are at rest, the projections 31 are away from the contacts 14. When a key 4 is actuated (FIG. 8), the corresponding boss 31 acts on the sensitive face of the associated micro-contact 14.

Thus, each zone 26 for bonding to a key 4 is at the same time a zone for transmitting actuation of the key 4 to a particular micro-contact 14, via a projection 31 carried by this zone. The two zones 26 associated with a single key 4 are connected by a bracket 33 in form of a channel opening towards the base 13. The hollow of this channel accommodates the pin 19.

For assembly of the keypad, there is manufactured separately on the one hand the base 13, and on the other hand the actuation sub-assembly by bonding the keys onto the interface 17. Then the pivot bearings 21 and 22 are aligned, the pin 19 is inserted and immobilized axially by means of the trim covers 3 (FIG. 1).

FIGS. 2 and 3 show the multi-strand ribbon cable 34 by which the micro-contacts 14 can be connected to the electronics of the player (not shown).

In the modified embodiment represented in FIG. 9, the key 4 has an unsymmetrical profile with a concave actuation face 6v and convex actuation face 6x, to facilitate tactile location by the user.

Of course, the invention is not limited to the examples described and shown.

A device according to the invention can have two keypads instead of a single one, the navigator being for example a separate keypad. A device according to the invention can also have conventional keys with a single actuation surface, in addition to a keypad according to the invention.

The keypad according to the invention can be placed on a face corresponding to the thickness of the player, or on a face which is sloped with respect to the face carrying the screen.

The base or other underlying structure can comprise fewer pivot bearings such as 21, some of which can advantageously be replaced by braces which maintain the functional clearance required between adjacent keys.

The pivot bearings 21 or 22 can be shaped as open bearings which clip onto the pin such as 19.

The keys can be fixed onto the interface by a means other than bonding, for example clipping.

The clearance “j” between keys can be ensured by a collar which extends the flank of the key close to the axis of rotation, or also by the positioning of the keys on the interface.

1. Keypad for a device provided with a screen, in particular a portable video player, characterized in that it comprises at least one control key (4) having on either side of an inactive zone (7) situated over a mechanical support for the key, two opposite zones (6) actuated by being depressed by the user, for controlling two different functions.

2. Keypad according to claim 1, characterized in that the two different functions are antinomic.

3. Keypad according to claim 1, characterized in that at least one of the two different functions is shown on the screen (1) by a graphical representation (42) of at least one corresponding key (4).

4. Keypad according to claim 1, characterized in that the two actuation zones (6x, 6v) have differences in shape which can be felt by the user's finger.

5. Keypad according to claim 1, characterized in that the keypad comprises a base (13) comprising actuation detectors (14), in particular contacts, each associated with one of the actuation zones (6) of the key (4).

6. Keypad according to claim 5, characterized in that the mechanical support of the inactive zone of the key is ensured relative to the base (13).

7. Keypad according to claim 1, characterized in that the mechanical support is provided in the form of hinging the key (4) with a base (13).

8. Keypad according to claim 7, characterized in that the hinge comprises a pin (19) extending through at least one pivot bearing (22) carried by the key (4) and at least one pivot bearing (21) carried by the base (13).

9. Keypad according to claim 7, characterized in that said at least one key comprises at least two adjacent keys (4a . . . 4e) hinged to the base (13) by a pin (19) common to said two keys.

10. Keypad according to claim 9, characterized in that the base (13) and the keys (4, 4a . . . 4e) comprise pivot bearings (21, 22) through which the common pin (19) extends and which laterally abut each other to define an axial clearance (j) between keys.

11. Keypad according to claim 8, characterized in that said at least one key (4) is assembled with the base (13) simply by putting the pin in place (19).

12. Keypad according to claim 5, characterized in that it comprises a pre-stressed elastomer interface (17) in compression between said at least one key (4) and the base (13).

13. Keypad according to claim 1, characterized in that said at least one key comprises at least two keys pre-assembled together by being attached onto an interface (17) which is common to the two keys.

14. Keypad according to claim 12, characterized in that the interface (17) carries actuation projections (31) on its face facing away from to the keys (4).

15. Keypad according to claim 12, characterized in that the interface (17) carries localized support projections (29) on its face facing away from the keys (4), the localized support projections (29) being intended to bear permanently onto an underlying surface (18).

16. Keypad according to claim 1, characterized in that at least one key comprises at least two adjacent keys, and in that it comprises a tactile identification pattern (11, 12, 12a) common to the two keys, which straddles the two keys on their respective face which is accessible to the user.

17. Keypad according to claim 1, characterized in that said at least one key comprises at least three adjacent keys (4c, 4d, 4e), namely a central key (4d) for controlling two navigation functions in two opposing directions, and two side keys (4c, 4e) each controlling two other functions, comprising a navigation function respectively in one of the two directions perpendicular to the two opposing directions of the central key.

18. Keypad according to claim 17, characterized in that the second function controlled by each of the two side keys (4c, 4e) is an accelerated navigation function.

19. Keypad according to claim 17, characterized in that it comprises a tactile identification pattern (11), preferably a recess, with a contour extending over the three keys (14c, d, e).

20. Keypad according to claim 1, characterized in that the mechanical support such as a hinge pin is situated in the vicinity of a plane containing sensitive faces of the actuation detectors (14), preferably with an offsetting of the pin towards the keys.

21. Compact portable device with a screen (1), of the pocket or handbag type, comprising a keypad (2) according to claim 1.

22. Device according to claim 21, characterized by being capable of displaying the image in two opposite directions, in which the keypad is positioned respectively to the right and to the left of the screen.

23. Device according to claim 22, characterized in that the keys of the keypad can be reversed on the base by a quick-mounting means, depending on the direction of use of the screen.
